(19) United States
(12) Patent Application Publication
(10) Pub. No.: US 2014/0019556 A1
(43) Pub. Date: Jan. 16, 2014

(54) Autism Social Media

(71) Applicant: Dana Michelle Hawkins, Enlgewood, CO (US)

(72) Inventor: Dana Michelle Hawkins, Enlgewood, CO (US)

(21) Appl. No.: 13/461,846

(22) Filed: Jul. 16, 2012

(51) Int. Cl. H04L 12/58

(52) U.S. Cl. CPC H04L 51/32
USPC 709/206

(57) ABSTRACT

A social media site where parents, guardians, caregivers and individuals of autism can interact with each other. The social media website can also provide articles and information regarding autism. The website can also provide books and other products that will provide entertainment, help and support.

### CROSS-REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The field of endeavor relates to the development and operation of a website as a social media site where parents, guardians, caregivers and individuals of autism can interact with each other. The applicable U.S. patent classification 705/319. The class 705 is data processing for financial, business practice, management, and cost or price determination. The subclass 319 refers to the subject matter of a computerized arrangement for the management of interaction between individuals or entities who are connected by one or more common relations or interest.

### BRIEF SUMMARY OF THE INVENTION

A social media site where parents, guardians, caregivers and individuals of autism can interact with each other. The range for the diagnosis for autism is so very broad. The social media can help to diminish myths and stereotypes. Individuals who care for those with autism will be able to provide ideas, resources and suggestions. The social media website can provide the much needed help and support. The parents, guardians, caregivers and individuals of autism who know “the tricks of the trade”, will inform and help. The parents, guardians, caregivers, and individuals of autism who are experiencing new hurdles, will receive the information and support they need.

The social media website can also provide articles and information regarding autism. The social media website can also provide books and other products that will provide entertainment, help and support. The social media will provide rules and warnings, to safeguards against predators; and those who look to take advantage of the vulnerable.

### BRIEF DESCRIPTION OF THE SEVERAL VIEWS OF DRAWING:

FIG. 1 shows various aspects on how to access hyperlinks for a social media for autism.

FIG. 2 shows various aspects on how to develop a social media for autism.

### DETAILED DESCRIPTION OF THE INVENTION:

A social media where parents, guardians, caregivers and individuals of autism can interact with each other. The social media website can also provide articles and information regarding autism. The social media can also provide books and other products that will provide entertainment, help, and support. The social media will establish rules to protect and safeguard the website, from those individuals who seek to take advantage of the visitors of the social media website for autism.

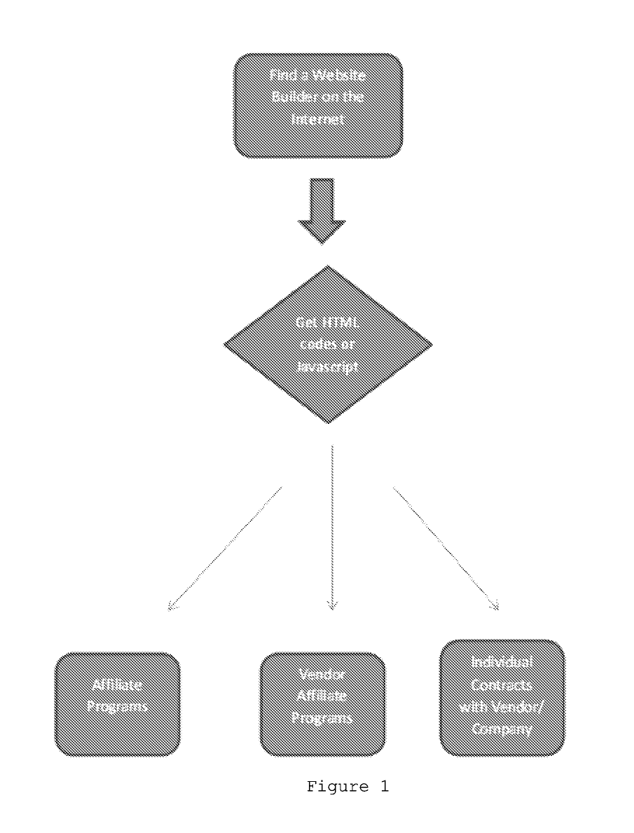

As shown in FIG. 1, the social media for autism is developed through computer programs. An individual can develop the social media website through a program that helps build websites or a person who is hire those skills. The website builders are found on the Internet. The social media would have helpful articles and current research regarding autism. The latter information will be transferred to the website by copy and pasting the information on to the website. The developer of the social media site would use the tools offer to them; in order to implement a forum or chat room on the website.

As shown in FIG. 1, the social media website for autism will distribute and sale; books and other prevalent products through the use of a “hyperlink”. A “hyperlink” was developed by Sir Timothy John “Tim” Berners-Lee. The “hyperlink” is use to link any information to any other information over the Internet. The website's pages are written in the hypertext mark-up system “HTML”. Hypertext is text with hyperlinks. The purpose of a web browser is to read “HTML” documents and compose them into visible or audible web pages. Hyperlinks present in websites enable users easily to navigate their browsers to the related resources. A web browser can also be defined as application software or program designed to enable users to access, retrieve, view documents and other resources on the Internet. The other hyperlink that can be use along with the “HTML” is “JavaScript”hyperlink. The “ JavaScript” was developed by Brendon Eich. “JavaScript” has become one of the most popular programming languages on the web. The JavaScript” hyperlink can also be place within the website's design to display the vendor, company or product.

As shown in FIG. 1, the social media website is able to receive its hyperlinks via affiliate programs. The affiliate programs can be obtained by registering with a company that allows the developer of the website to become a part of their program. There are a number of Internet companies that provide the latter service for example, Amazon, Commission Junction, Linkshare, and Google Affiliate Program (GAN), etc. The developer of the social media would register to one or more of these affiliate Internet companies. The Affiliate program companies would approve their entrance into the program. Then the developer would apply to a list of vendor or companies provided to then through the affiliate program. Those vendors or companies would review and approve the application provide by the social media for autism. Once approve by the vendors or companies the affiliate program represent; they would give the developer of the social media website the vendors' or companies' hyperlink. The developer of the social media would then proceed to copy and paste the hyperlinks provided to them, into the design of the webpage from the website builder.

As shown in FIG. 1, the social media is able to receive their hyperlinks through the vendor or company they are interested in displaying on the website. The vendors or companies can have their very own affiliate programs. The developer would contact the vendor or company they would like to display on the social media site, and apply for the vendor's or company's affiliate program. The vendors or companies would then have option to approve the application for the social media, and in doing so give the hyperlink for the website's webpage.

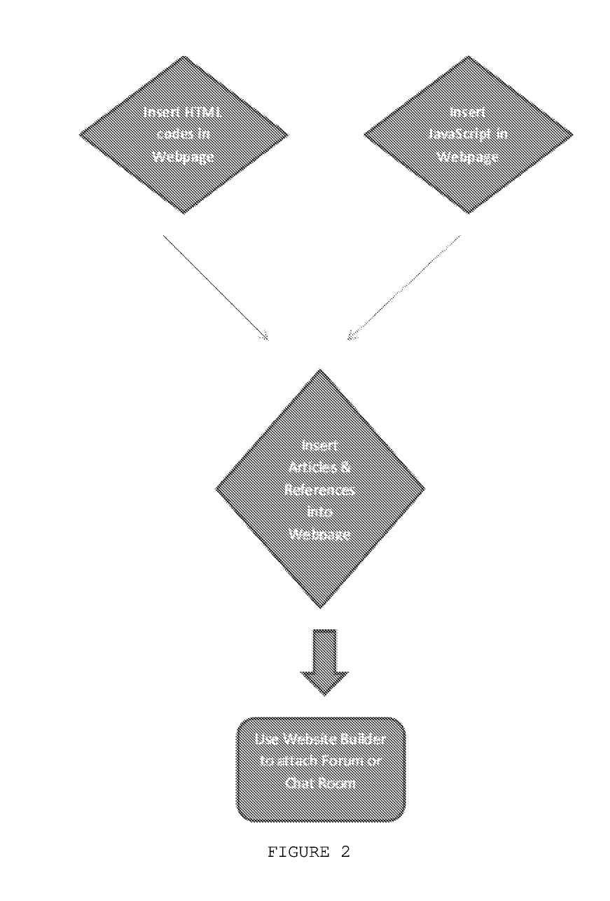

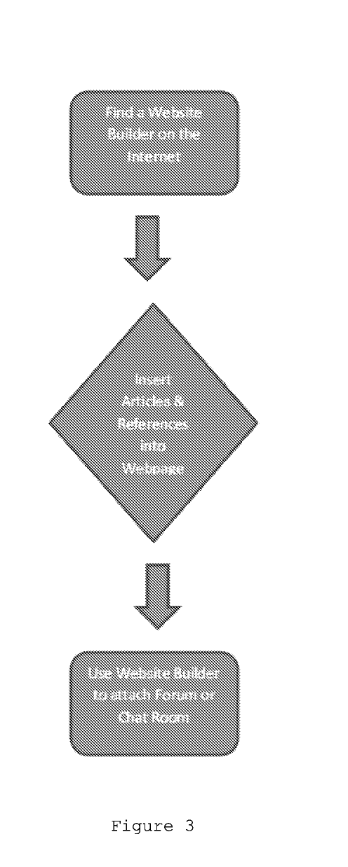

As shown in FIG. 1 and FIG. 2, the social media is able to receive their hyperlinks through vendors or companies that pay for advertising space on the website. The vendor or company would provide a contract agreement with the social media. The vendor or company would pay the social media to allow the latter to take up space on the website. The vendor or company would then provide the hyperlinks to the developer of the social media; to copy and paste into the design of the webpage of the website.

The social media for the teaching and understanding of parents, guardians, caregivers and individuals of autism is necessary support system. The social media will help will help society truly understand how to meet the special needs of these amazing individuals; who have so much to offer. The social media would provide new parents, guardians, caregivers the tools and information they so desperately need. It will give individuals with experience with autism to tell others what has helped them.

I Claim:

1. A method of a social media where parents, guardians, caregivers and individuals of autism can interact with each other comprising;

2. The method of providing a forum or a chat room, for said social media of autism.

3. The method of claim 2 providing individuals who care for those with autism a first means to provide ideas, resources and suggestions, for said social media of autism.

4. The method of claim 2 providing the social media of autism website can provide the help, resources, and support.

5. The method of claim 4 providing articles and information regarding autism for said social media of autism.

6. The method of claim 4 providing books; and other products, and tools for said social media of autism.

7. The method of providing autistic individuals the second means to discuss their said autism on said social media of autism.

8. The method of claim 7 providing entertainment, help and support for said social media of autism.

9. The method of providing rules and warnings, to safeguards against predators; and those who look to take advantage of the vulnerable of said social media of autism,
whereby the said social media of autism can help to diminish myths and stereotypes; and supply an outlet for parents, guardians, caregivers and individuals of autism; and provide support and resources.
